(19) United States
(12) Patent Application Publication
(10) Pub. No.: US 2026/0065625 A1
(43) Pub. Date: Mar. 5, 2026

(54) INFERENCE DEVICE AND INFERENCE METHOD

(71) Applicant: Hitachi, Ltd., Tokyo (JP)

(72) Inventor: Keisuke YAMAMOTO, Tokyo (JP)

(21) Appl. No.: 19/294,706

(22) Filed: Aug. 8, 2025

(30) Foreign Application Priority Data
Aug. 29, 2024 (JP) 2024-147474

(51) Int. Cl. G06V 10/34; G06V 10/26; G06V 10/36; G06V 10/82

(52) U.S. Cl. CPC G06V 10/34; G06V 10/26; G06V 10/36; G06V 10/82

(57) ABSTRACT

An inference device including an input unit that inputs image data continuous in a predetermined direction; a thinning processing unit that executes thinning of a plurality of pieces of image data input by the input unit such that a pixel array indicating a plurality of patterns is repeated and pixels in a spatial direction do not overlap, and outputs a plurality of pieces of thinned image data; a convolution arithmetic operation unit that performs a convolution arithmetic operation by applying a plurality of thinning filters configuring the plurality of patterns divided from a filter having a weighting factor to each of the plurality of pieces of thinned image data; an inference unit that executes inference regarding the plurality of pieces of image data using a time-series filter on a basis of a plurality of convolution arithmetic operation results; and an output unit that outputs an inference result.

### CLAIM OF PRIORITY

The present application claims priority from Japanese patent application No. 2024-147474 filed on Aug. 29, 2024, the content of which is hereby incorporated by reference into this application.

### BACKGROUND OF THE INVENTION

### 1. Field of the Invention

The present invention relates to an inference device and an inference method.

### 2. Description of the Related Art

Image processing sizes required for artificial intelligence (AI) processing have been expanded for in-vehicle and industrial Internet of Things (IoT). For example, even in AI processing performed on a high definition (HD) camera in a conventional application, processing of a plurality of 4K resolution cameras is required, and power consumption of computer resources for performing AI processing is also increasing.

While the processing performance required for AI is improved, there is a need for a computer resource and an AI chip that require low power consumption satisfying a fanless request in an application for an edge. It is difficult to perform AI processing on a high-resolution image while satisfying these requirements for power consumption. Conventionally, for reducing the power consumption of AI processing, a method of reducing the weight of an AI model by pruning or quantization by specializing in inference processing is often used.

Yang He, Lingao Xiao, “Structured Pruning for Deep Convolutional Neural Networks: A survey”, IEEE trans. PAMI, 2023 discloses various types of pruning techniques of a convolutional neural network (CNN). Wakana Nogami, et. al., “Optimizing Weight Value Quantization for CNN Inference”, IJCNN, 2019 discloses a technique of reducing the amount of memory for storing multiplication processing and weights by optimizing the number of bits used for CNN weights.

### SUMMARY OF THE INVENTION

However, in the above-described conventional technology, it is difficult to realize required performance of AI processing in recent years, and a further power efficiency improvement method is desired.

An object of the present invention is to reduce power consumption by reducing the amount of convolution arithmetic operation.

An inference device according to one aspect of the invention disclosed in the present application includes: an input unit that inputs a plurality of pieces of image data continuous in a predetermined direction; a thinning processing unit that executes thinning processing of thinning each of a plurality of pieces of image data input by the input unit in such a way that a pixel array indicating a plurality of patterns is repeated and pixels in a spatial direction do not overlap, and outputs a plurality of pieces of thinned image data; a convolution arithmetic operation unit that performs a convolution arithmetic operation by applying a plurality of thinning filters configuring the plurality of patterns divided from a filter having a weighting factor to each of the plurality of pieces of thinned image data; an inference unit that executes inference regarding the plurality of pieces of image data using a time-series filter on a basis of a plurality of convolution arithmetic operation results by the convolution arithmetic operation unit; and an output unit that outputs an inference result by the inference unit.

An inference device according to another aspect of the invention disclosed in the present application includes: an input unit that inputs a plurality of pieces of image data continuous in a predetermined direction; a thinning processing unit that executes thinning processing of thinning each of a plurality of pieces of image data input by the input unit in such a way that a pixel array indicating a plurality of patterns is repeated and pixels in a spatial direction do not overlap, and outputs a plurality of pieces of thinned image data; a convolution arithmetic operation unit that combines a plurality of pieces of thinned image data thinned by the thinning processing unit to generate combined thinned image data, and applies a filter having a weighting factor to the combined thinned image data to perform a convolution arithmetic operation; an inference unit that executes inference regarding the plurality of image data using a time-series filter on a basis of a convolution arithmetic operation result by the convolution arithmetic operation unit; and an output unit that outputs an inference result by the inference unit.

According to the representative embodiment of the present invention, it is possible to achieve low power consumption by reducing the amount of the convolution arithmetic operation. Objects, configurations, and effects besides the above description will be apparent through the explanation on the following embodiments.

### BRIEF DESCRIPTION OF THE DRAWINGS

FIG. 1 is a block diagram illustrating an exemplary hardware configuration of an inference device;

FIG. 2 is a block diagram illustrating a functional configuration example of the inference device;

FIG. 3 is an explanatory diagram illustrating a configuration example of a convolution network;

FIG. 4 is an explanatory diagram illustrating a convolution processing example in the convolution network;

FIG. 5 is an explanatory diagram illustrating a second convolution processing example in the convolution network;

FIG. 6 is an explanatory diagram illustrating an example of thinning of input image data at a thinning rate of 1/2;

FIG. 7 is an explanatory diagram illustrating an example of applying a filter to thinned image data at a thinning rate of 1/2;

FIG. 8 is an explanatory diagram illustrating an example of thinning of input image data at a thinning rate of 1/3;

FIG. 9 is an explanatory diagram illustrating an example of CNN filter division at a thinning rate of 1/3;

FIG. 10 is an explanatory diagram illustrating an example of applying a CNN filter to thinned image data at a thinning rate of 1/3;

FIG. 11 is an explanatory diagram illustrating a third convolution processing example at a thinning rate of 1/2;

FIG. 12 is an explanatory diagram illustrating a third convolution processing example at a thinning rate of 1/3;

FIG. 13 is an explanatory diagram illustrating an operation switching example of a signal processing unit 202;

FIG. 14 is an explanatory diagram illustrating an example of combination weight control in the time direction in the thinning CNN processing; and

FIG. 15 is an explanatory diagram illustrating an example of time-series filter combination in thinning CNN processing.

### DESCRIPTION OF THE PREFERRED EMBODIMENTS

Hereinafter, embodiments of the present invention will be described with reference to the drawings. The embodiments are exemplifications for describing the present invention, and are omitted and simplified as appropriate for clarification of the description. The present invention can be implemented in other various forms. When there are a plurality of components having the same or similar functions, different subscripts may be given for the same reference numerals for explanation. In addition, when there is no need to distinguish between these components, the description may be omitted with subscripts omitted.

In the embodiment, a process performed by executing a program may be described. Here, a computer executes a program by a processor (for example, CPU, GPU), and performs a process defined by the program while using a storage resource (for example, memory), an interface device (for example, a communication port), and the like. Therefore, the subject of the processing performed by executing the program may be the processor. Similarly, the subject of the process performed by executing the program may be a controller, an apparatus, a system, a computer, or a node, which have a processor.

Furthermore, in the embodiment, in a case where a deep neural network (DNN) processing unit is included as an accelerator for performing specific processing at high speed in addition to a general-purpose processor, DNN processing with a heavy arithmetic load is performed by the DNN processor. At this time, it is possible to further increase the power efficiency by performing signal processing in consideration of the utilization rate of the parallel computation unit.

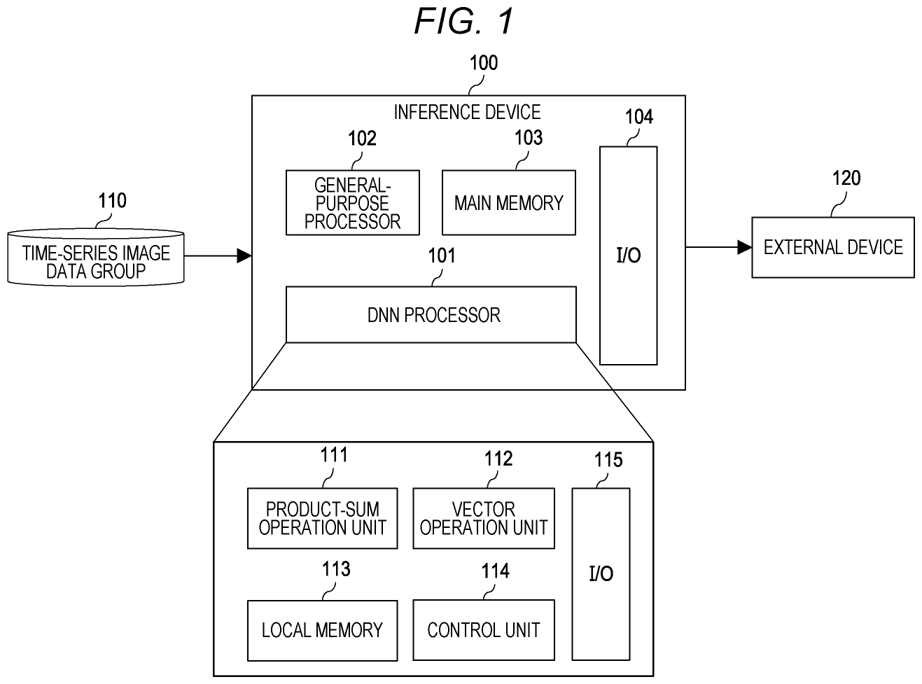

### <FIG. 1 Exemplary Hardware Configuration of Inference Device>

FIG. 1 is a block diagram illustrating an exemplary hardware configuration of an inference device. An inference device 100 includes a DNN processor 101, a general-purpose processor 102, a main memory 103, and an I/O interface 104.

The DNN processor 101 is hardware specialized for DNN processing. The signal processing that can be executed by the DNN processor 101 is limited as compared with the general-purpose processor 102. The general-purpose processor 102 executes general-purpose processing that cannot be performed by the DNN processor 101. Since it is determined that the DNN processor 101 performs only specific processing, the general-purpose processor 102 is unnecessary in a case where it is not necessary to handle general-purpose processing. On the other hand, in a case where performance of general-purpose processing is emphasized, the DNN processor 101 is unnecessary.

The I/O interface 104 receives an input of the time-series image data group 110 from the camera, receives an input of distance information of a subject from the camera or a sensor (for example, LiDAR) not illustrated, and outputs execution results of the DNN processor 101 and the general-purpose processor 102 and the time-series image data group 110 to an external device 120. The time-series image data group 110 is a series of digital image data having an order in terms of time, and is, for example, moving image data. The external device 120 displays the execution results of the DNN processor 101 and the general-purpose processor 102 and the time-series image data group 110.

The DNN processor 101 includes a product-sum operation unit 111 that performs product-sum operation (convolution arithmetic operation) of a matrix at high speed, a vector operation unit 112 that performs specific pipeline processing such as pipelining of an activation function of DNN, an accumulator for normalization, and division, a local memory 113, a control unit 114, and an I/O interface 115.

The I/O interface 115 inputs data to the DNN processor 101 and outputs data calculated by the DNN processor 101. The local memory 113 stores the time-series image data group 110 input to the DNN processor 101 and the intermediate result of the DNN processing. The product-sum operation unit 111 and the vector operation unit 112 read and write data from the local memory 113, and execute as many arithmetic operation processes as possible using the time-series image data group 110 and the intermediate result of the DNN processing. The control unit 114 controls and generates an address to read from or write to the local memory 113 according to the thinning rate or the thinning pattern, and inputs only necessary data to the product-sum operation unit 111 and the vector operation unit 112. Furthermore, the control unit 114 sets a time constant at the time of combining probabilities for the product-sum operation unit 111 and the vector operation unit 112.

As a result, the access frequency between the main memory 103 and the DNN processor 101 of the inference device 100 and the data size of the data stored in the main memory 103 are reduced, and the power efficiency of the inference device 100 is improved. Therefore, a method of reducing the time-series image data group 110 input to the DNN processor 101 used in one processing and the intermediate result of the DNN processing is effective.

The following describes a case of including both the DNN processor 101 and the general-purpose processor 102 unless otherwise specified.

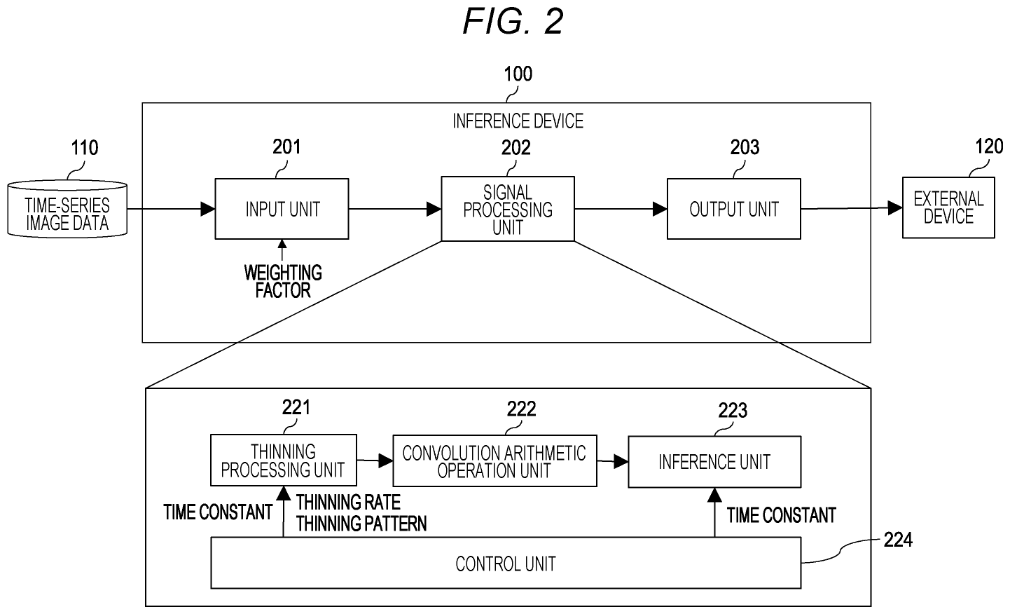

### <FIG. 2 Functional Configuration Example of Inference Device 100>

FIG. 2 is a block diagram illustrating a functional configuration example of the inference device 100. The inference device 100 includes an input unit 201, a signal processing unit 202, and an output unit 203. The input unit 201 inputs the time-series image data group 110 and the weighting factor of the CNN filter. The input unit 201 passes the time-series input image data and the weighting factor constituting the time-series image data group 110 to the signal processing unit 202.

The output unit 203 outputs the execution results of the DNN processor 101 and the general-purpose processor 102 and the time-series image data group 110 to the external device 120. The input unit 201 and the output unit 203 include the I/O interface 104 illustrated in FIG. 1. The signal processing unit 202 processes the time-series image data group 110 and executes AI inference. The signal processing unit 202 includes a DNN processor 101, a general-purpose processor 102, and a main memory 103.

The signal processing unit 202 includes a thinning processing unit 221, a convolution arithmetic operation unit 222, an inference unit 223, and a control unit 224. The thinning processing unit 221 executes thinning processing of thinning each of a plurality of input image data continuous in the time direction so that a pixel array indicating a plurality of patterns is repeated and pixels in the spatial direction do not overlap, and outputs a plurality of pieces of thinned image data. Such a thinning processing is defined by a thinning rate and a thinning pattern (described later in a second convolution processing example and a third convolution processing example). Furthermore, the thinning processing unit 221 may determine the number of pieces of thinned image data having different times by a time constant, or may combine these pieces of thinned image data (described later in the second convolution processing example and the third convolution processing example).

The convolution arithmetic operation unit 222 performs a convolution arithmetic operation on the thinned image data from the thinning processing unit 221 by the CNN filter to which the weighting factor is set, and outputs a convolution arithmetic operation result to the inference unit 223. The CNN filter is divided by a thinning pattern (described later in the second convolution processing example).

The inference unit 223 combines the convolution arithmetic operation result from the convolution arithmetic operation unit 222 with a time-series filter that combines the results in the time direction, and outputs an inference result. The time-series filter is, for example, a Kalman filter or a particle filter.

The control unit 224 controls a time constant, a thinning rate, and a thinning pattern applied to the thinning processing unit 221. Furthermore, the control unit 224 controls a time constant applied to the inference unit 223. For example, when the inference device 100 is an on-vehicle device, the control by the control unit 224 is executed on the basis of vehicle and road traffic information such as an own vehicle speed, weather, map information, and scene information, and preset information.

For example, in a case where the control unit 224 determines that the vehicle is traveling on an expressway from the own vehicle speed and the map information, detection of a distant front vehicle is a main task. Therefore, the control unit 224 sets the thinning rate lower than the thinning rate in traveling on an ordinary road. This suppresses deterioration in detection accuracy of a small object. In addition, in a case where the control unit 224 determines that the vehicle is traveling on an expressway from the own vehicle speed and the map information, a quick brake response is required, and thus the time constant is set to be smaller than the time constant in traveling on an ordinary road. In this manner, the time constant and the thinning rate are set.

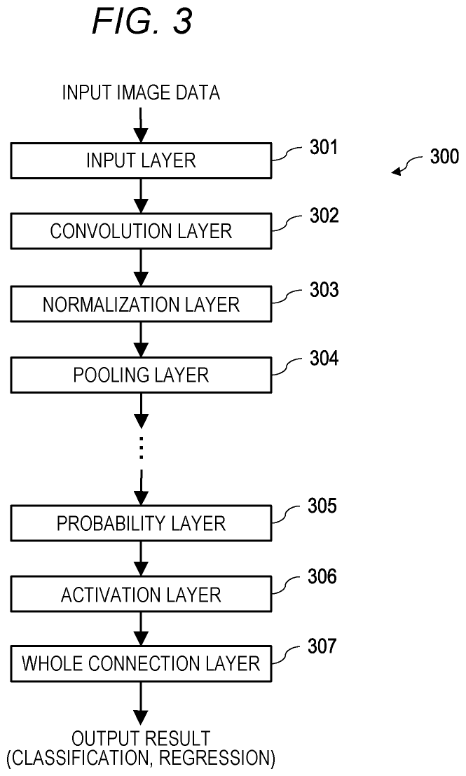

### <FIG. 3 Configuration Example of Convolution Network>

FIG. 3 is an explanatory diagram illustrating a configuration example of a convolution network. A convolution network 300 has a structure in which various processing layers such as an input layer 301, a convolution layer 302, a normalization layer 303, a pooling layer 304, a probability layer 305, an activation layer 306, and a whole connection layer 307 are superimposed in multiple stages in the DNN processor 101. Among these, processing for performing a product-sum operation of a large amount of weights, input data, and feature amounts is generally executed by the DNN processor 101. Processing of a layer that cannot be handled by the DNN processor 101 is executed by the general-purpose processor 102. In general, the processing of the convolution layer 302 in the convolution network 300 has a large operation amount, and the power efficiency of the entire inference processing can be improved by efficiently performing the processing of the convolution layer 302.

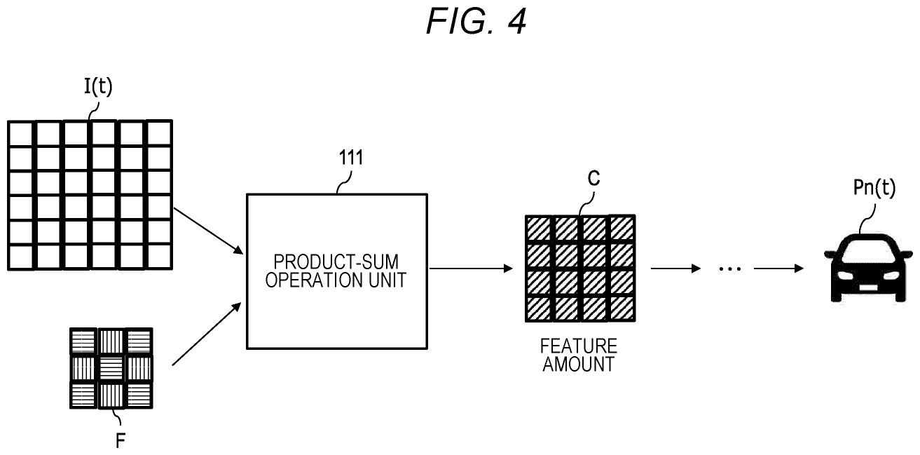

### <FIG. 4 First Convolution Processing Example in Convolution Network 300>

FIG. 4 is an explanatory diagram illustrating a convolution processing example in the convolution network 300. The convolution network 300 executes a convolution arithmetic operation on the input image data I(t) at the time t by the product-sum operation unit 111 using a CNN filter F having a 3×3 kernel size. The convolution arithmetic operation result is output to the next layer as a feature amount C. Finally, through processing in the convolution network 300, inference results Pn(t) at various times t such as regression, classification, and object recognition are output.

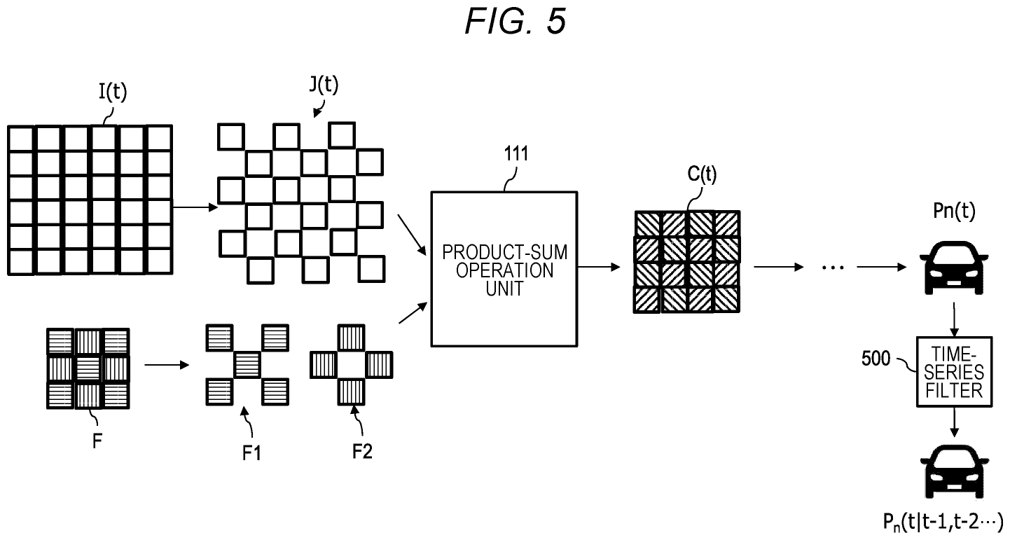

### <FIG. 5 Second Convolution Processing Example in Convolution Network 300>

FIG. 5 is an explanatory diagram illustrating a second convolution processing example in the convolution network 300. The second convolution processing example illustrates thinning convolution processing. The thinning convolution processing is a process of thinning pixels in the input image data I(t) according to a thinning rate using the fact that the input image data I(t) has a correlation in the time direction.

The thinning rate is a frequency at which pixels are thinned in the input image data I(t). When the thinning rate is 1/p (p is an integer of 2 or more), it indicates that one pixel among p pixels continuous in the spatial direction (row direction, column direction) and the time direction is thinned out in the spatial direction and the time direction. In FIG. 5, since the thinning rate is 1/2, the input image data I(t) is thinned pixel by pixel in the spatial direction and the time direction to become thinned image data J(t). In FIG. 5, the input image data I(t) is 6×6 pixels.

In the thinning convolution processing, a first CNN filter F1 and a second CNN filter F2 are prepared in which a CNN filter 400 is also thinned for each pixel according to the thinning rate of 1/2. When the first CNN filter F1 and the second CNN filter F2 are combined, the original CNN filter F is obtained.

The product-sum operation unit 111 alternately applies the first CNN filter F1 and the second CNN filter F2 to the thinned image data J(t), so that the convolution arithmetic operation result outputs a feature amount 510. That is, the first CNN filter F1 and the second CNN filter F2 are applied in a cycle based on the thinning rate (once every two times when the thinning rate is 1/2). A feature amount C(t) that is the convolution arithmetic operation result is output to the next layer. Therefore, if the thinning rate is 1/p, the divided p CNN filters F1, F2, . . . , and Fp are applied once every p times.

Through processing in the convolution network 300, inference results Pn(t) at various times t such as regression, classification, and object recognition are output. Then, the inference device 100 combines the inference results Pn(t), Pn(t−1), Pn(t−2), . . . at the times t, t−1, t−2, . . . by using the time-series filter 500 so as to output inference result Pn(t|t−1, t−2, . . . ). As a result, the operation amount of the entire inference device 100 is reduced, and accuracy degradation is suppressed.

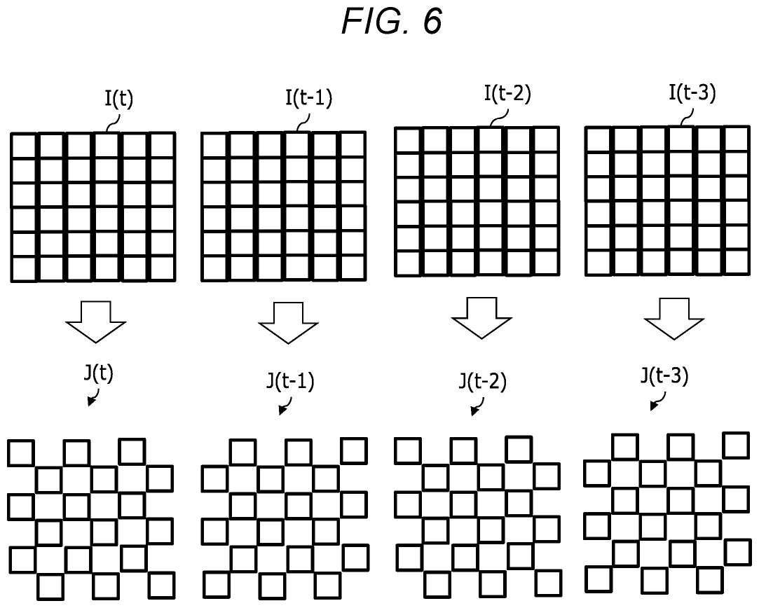

### [FIG. 6 Example of Thinning of Input Image Data I(t) to I(t−3) at Thinning Rate of 1/2]

FIG. 6 is an explanatory diagram illustrating an example of thinning of input image data I(t) to I(t−3) at a thinning rate of 1/2. FIG. 6 illustrates an example of thinning of the input image data I(t) to I(t−3) in a case where the thinning rate is set to 1/2. The thinned image data J(t) to J(t−3) is image data thinned out from the input image data I(t) to I(t−3) at a thinning rate of 1/2.

In a case where the input image data I(t) to I(t−3) is not distinguished, this data is referred to as input image data I. In a case where the thinned image data J(t) to J(t−3) is not distinguished, this data is referred to as thinned image data J.

In the case of the thinning rate of 1/2, the thinned image data J(t) and the thinned image data J(t−2) become the same image data, and the thinned image data J(t−1) and the thinned image data J(t−3) become the same image data.

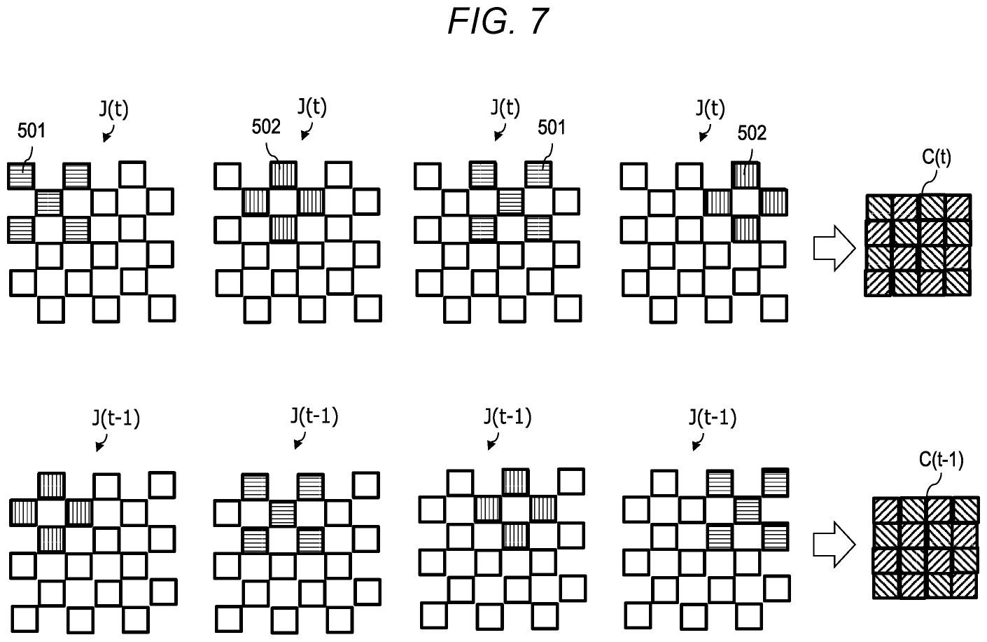

### [FIG. 7 Application Example of CNN Filter to Thinned Image Data J(t) and J(t−1) at Thinning Rate of 1/2]

FIG. 7 is an explanatory diagram illustrating an example of filter application to the thinned image data J(t) and J(t−1) at a thinning rate of 1/2. In the thinned image data J(t), the first CNN filter F1 and the second CNN filter F2 are alternately applied in this order. The stride of the first CNN filter F1 and the second CNN filter F2 is 2. As a result, the feature amount C(t) is calculated as a convolution arithmetic operation result.

In the thinned image data J(t−1), the second CNN filter F2 and the first CNN filter F1 are alternately applied in this order. The stride of the first CNN filter F1 and the second CNN filter F2 is 2. As a result, the feature amount 510 (t−1) is calculated as a convolution arithmetic operation result.

The weight used in the second convolution processing example is a part of the weight of the kernel, and in a case where the input image data I is regularly thinned out at a thinning rate of 1/2, the kernel to be slid and multiplied by the input image data I is substantially divided into two types of the first CNN filter F1 and the second CNN filter F2, and the number of times of multiplication when the pixels of the respective feature amounts are output is reduced. In the calculation using the time-series filter 500 after convolution, for example, in a case where the probability of object recognition is output as the inference result Pn(t), the inference results Pn(t−1), Pn(t−2), . . . are combined with the inference result Pn(t) by calculating the conditional probability at the previous times t−1, t−2, . . . using the time-series filter 500.

In a case where the change in the time direction of the input image data I is sufficiently small, a large gain can be obtained by increasing the time constant of the time-series filter 500, but in a case where the change in the time direction is large, accuracy degradation occurs. Therefore, the time constant for determining the time range of the combination target inference result Pn among the inference results Pn(t), Pn(t−1), Pn(t−2), . . . needs to be appropriately selected for each scene.

In general, by setting the time constant sufficiently small, it is possible to obtain a minimum combined gain while suppressing the possibility of occurrence of accuracy deterioration. In a case where the change in the time direction of the input image data I from the camera is predicted to be small from the own vehicle speed, the information from the external sensor, and the road traffic information, the accuracy is improved by increasing the combined gain by increasing the time constant.

In the determination of the time range of the inference result Pn to be combined to which the time constant is applied, data from the time t to n time may be simply combined, or the influence of the past time effectively away from the time t may be reduced using a function that decays exponentially. For example, when combined inference result at times t, t−1, and t−2 is Y(t), and inference results before combining at times t, t−1, and t−2 are X(t), X(t−1), and X(t−2), respectively, an implicit determination of the time range of the combination target inference result Pn using a time constant t is expressed by the following Expression (1).

$$Y ( t ) = X ( t ) + X ( t - 1 ) \times exp ( - 1 / τ ) + X ( t - 2 ) \times exp ( - 2 / τ ) \qquad ( 1 )$$

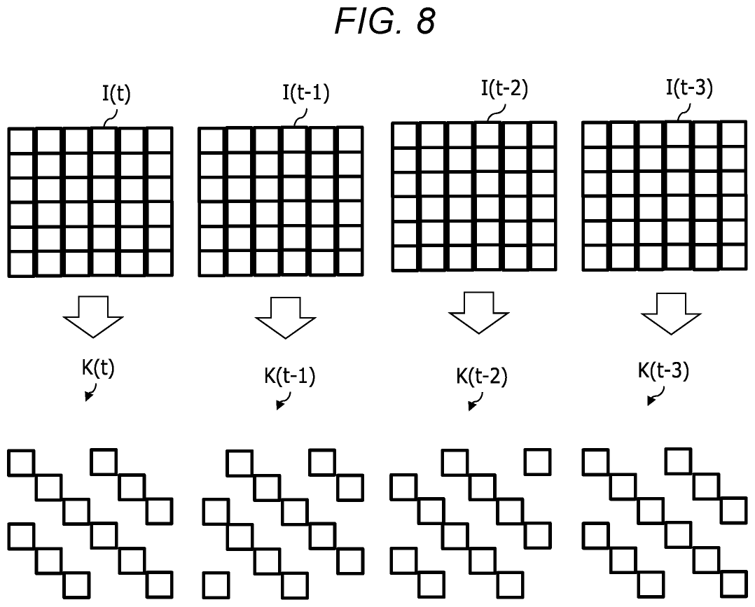

### [FIG. 8 Example of Thinning of Input Image Data I(t) to I(t−3) at Thinning Rate of 1/3]

FIG. 8 is an explanatory diagram illustrating an example of thinning of input image data I(t) to I(t−3) at a thinning rate of 1/3. In the case of the thinning rate of 1/3, the input image data I(t) to I(t−3) are subjected to a thinning processing to become thinned image data K(t) to K(t−3). The thinned image data K(t) to K(t−2) are image data in which pixels to be thinned are different. The thinned image data K(t) and the thinned image data K(t−3) are the same image data.

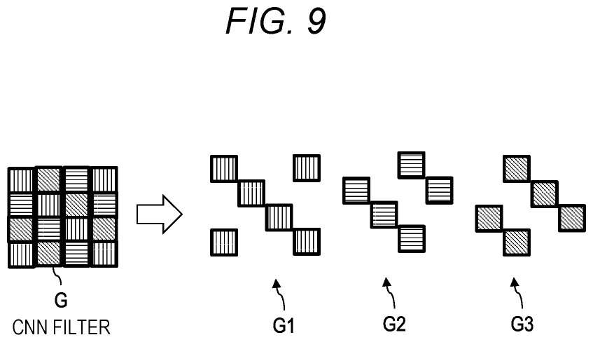

### [FIG. 9 Example of CNN Filter Division at Thinning Rate of 1/3]

FIG. 9 is an explanatory diagram illustrating an example of CNN filter division at a thinning rate of 1/3. In the case of the thinning rate of 1/3, the 4×4 CNN filter G is divided into a first CNN filter G1, a second CNN filter G2, and a third CNN filter G3. When the first CNN filter G1, the second CNN filter G2, and the third CNN filter G3 are combined, the original CNN filter G is obtained.

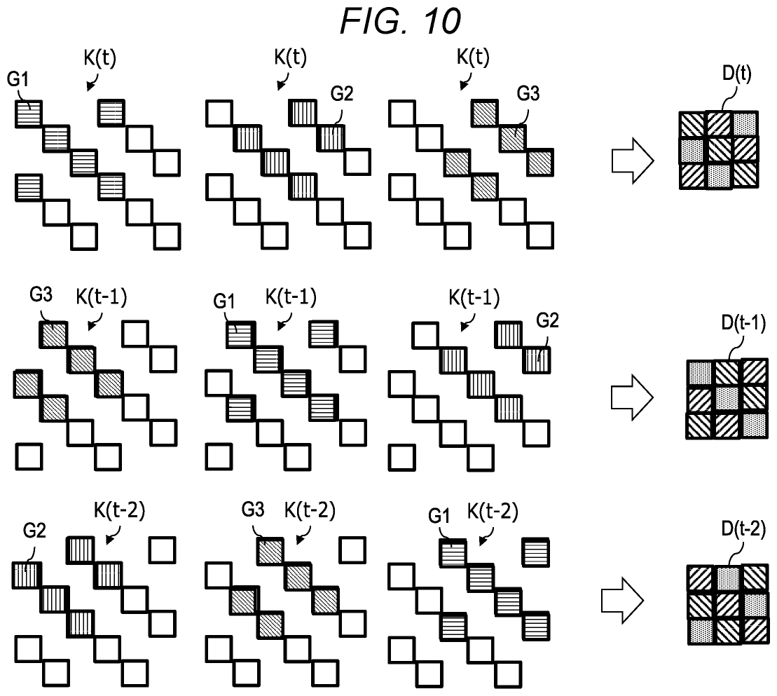

### [FIG. 10 Example of Applying CNN Filter to Thinned Image Data K(t), K(t−1), and K(t−2) at Tatami Thinning Rate of 1/3]

FIG. 10 is an explanatory diagram illustrating an example of applying the CNN filter to the thinned image data K(t), K(t−1), and K(t−2) at a thinning rate of 1/3. The stride of the first CNN filter G1, the second CNN filter G2, and the third CNN filter G3 is 3. In the thinned image data K(t), the first CNN filter G1, the second CNN filter G2, and the third CNN filter G3 are applied in this order. As a result, the feature amount D(t) is calculated as a convolution arithmetic operation result.

In the thinned image data K(t−1), the third CNN filter G3, the first CNN filter G1, and the second CNN filter G2 are applied in this order. As a result, the feature amount D(t−1) is calculated as a convolution arithmetic operation result. In the thinned image data K(t−2), the second CNN filter G2, the third CNN filter G3, and the first CNN filter G1 are applied in this order. As a result, the feature amount D(t−2) is calculated as a convolution arithmetic operation result.

Note that, in the second convolution processing example, the cases where the thinning rates are 1/2 and 1/3 have been exemplified, but the thinning rates other than 1/2 and 1/3 are also applicable. Note that the thinning pattern may be any pattern as long as fluctuation in image degradation can be tolerated.

Furthermore, the thinning processing can be executed not on the input image data I(t) and I(t−1) but on the feature amounts C(t) and C(t−1).

The input image data I(t) and I(t−1) and the feature amounts C(t) and C(t−1) thereof also have dimensions in the channel direction. Therefore, also in the channel direction, similarly to the time direction, pixel thinning and combination in the time-series filter 500 can be applied. In particular, since the channel direction is convolved by the peripheral pixels of the target pixel, the channel direction is resistant to positional displacement, and it is easy to allow fluctuation of deterioration when thinning is performed with an arbitrary thinning pattern.

### <Third Convolution Processing Example of Convolution Network 300>

Next, a third convolution processing example of the convolution network 300 will be described. Generally, in an accelerator for a neural network, high efficiency is realized by simultaneously operating a large number of arithmetic units in parallel. Generally, these pieces of hardware realize the maximum efficiency in the arithmetic operation of the dense matrix. Therefore, in order to skip the multiplication processing of a part of the kernels of the CNN filters F and G, special instruction overheads and a hardware mechanism are often required, and in the hardware not having such a mechanism, the effect of reducing the operation amount may not be effectively exhibited.

In the third convolution processing example, the CNN filters F and G are used as they are without being divided into a plurality of parts. Therefore, the operation amount is reduced as compared with the second convolution processing example.

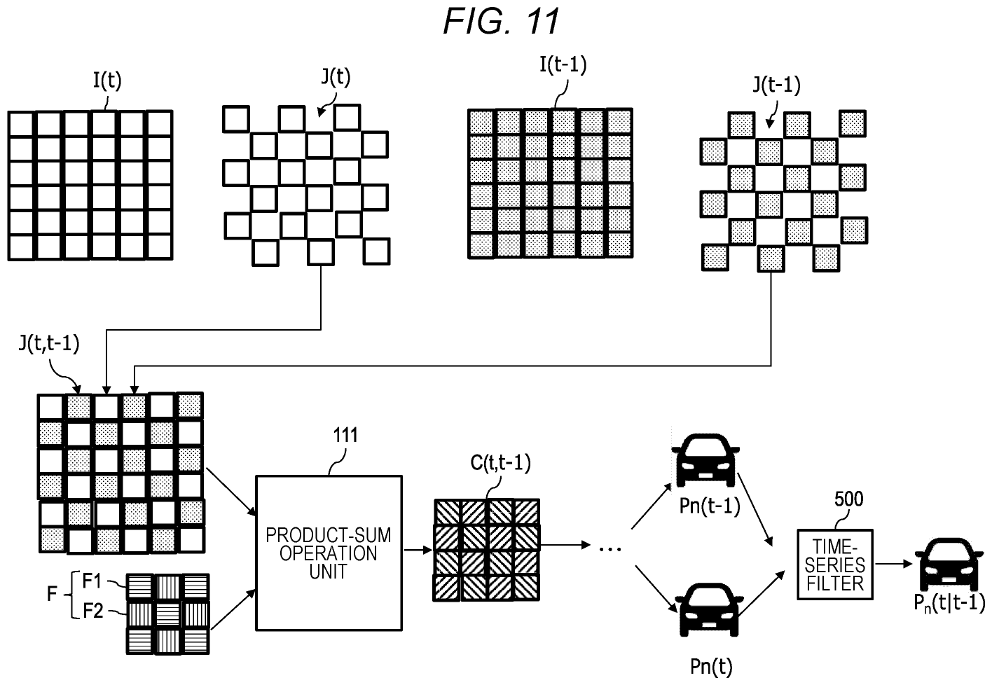

### [FIG. 11 Third Convolution Processing Example at Thinning Rate of 1/2]

FIG. 11 is an explanatory diagram illustrating the third convolution processing example at a thinning rate of 1/2. The inference device 100 generates the thinned image data J(t) and J(t−1) from the input image data I(t) and I(t−1) at the plurality of times t and t−1. The inference device 100 combines the thinned image data J(t) and J(t−1) to generate combined thinned image data J(t, t−1).

Similarly to FIG. 4, the product-sum operation unit 111 performs a convolution arithmetic operation on the combined thinned image data J(t, t−1) with the CNN filter F to generate the combined feature amount C(t, t−1) obtained by collecting the feature amounts C(t) and C(t−1) at the times t and t−1. The feature amount C(t, t−1) is output to the next layer. Through the processing in the convolution network 300, various inference results Pn(t) at time t−1 and inference results Pn(t−1) at time t such as regression, classification, and object recognition are output. Then, the inference device 100 combines the inference results Pn(t) and Pn(t−1) at the times t and t−1 using the time-series filter 500 to output the inference result Pn(t|t−1).

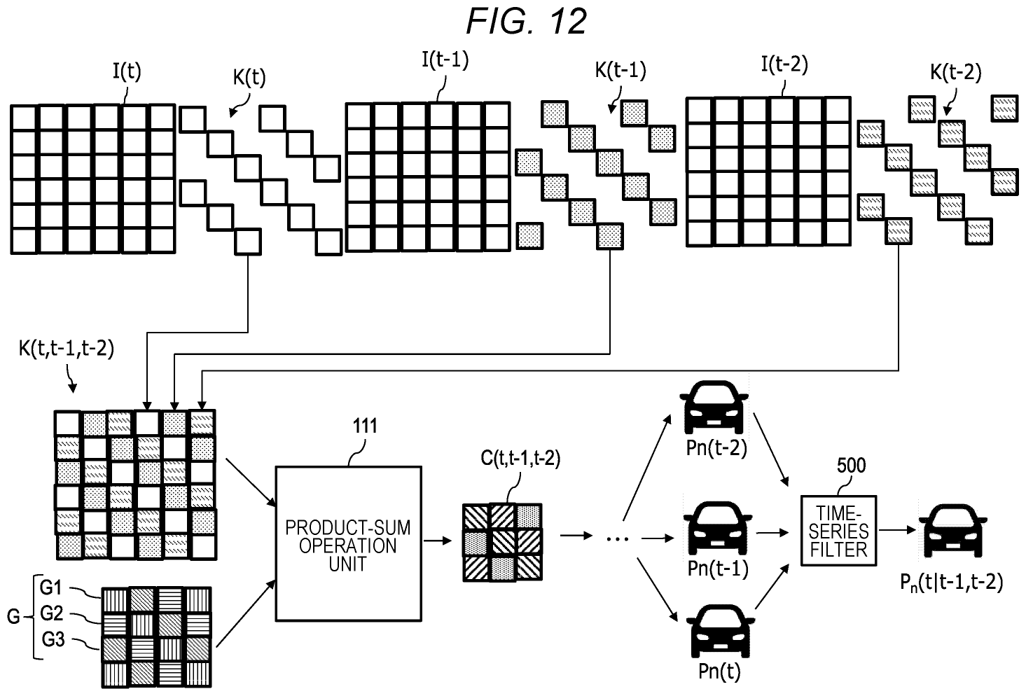

### [FIG. 12 Third Convolution Processing Example at Thinning Rate of 1/3]

FIG. 12 is an explanatory diagram illustrating the third convolution processing example at a thinning rate of 1/3. The inference device 100 generates the thinned image data K(t), K(t−1), and K(t−2) from the input image data I(t), I(t−1), and I(t−2) at the plurality of times t, t−1, and t−2. The inference device 100 combines the thinned image data K(t), K(t−1), and K(t−2) to generate combined thinned image data K(t, t−1, t−2).

Similarly to FIG. 4, the product-sum operation unit 111 performs a convolution arithmetic operation on the combined thinned image data K(t, t−1, t−2) with the CNN filter G to generate a combined feature amount D(t, t−1, t−2) obtained by collecting the feature amounts D(t), D(t−1), and D(t−2) at the times t, t−1, and t−2. The feature amount C(t, t−1, t−2) is output to the next layer. Through the processing in the convolution network 300, various inference results Pn(t) at time t, inference results Pn(t−1) at time t−1, and inference results Pn(t−2) at time t−2, such as regression, classification, and object recognition, are output. Then, the inference device 100 combines the inference results Pn(t), Pn(t−1), and Pn(t−2) at the times t, t−1, and t−2 using the time-series filter 500 to output the inference result Pn(t|t−1, t−2).

As described above, in the third convolution processing example, the inference device 100 executes the arithmetic operation with all the weights of the kernels of the CNN filters F and G by collecting the thinned image data thinned out from each other at a plurality of times, and outputs the combined feature amounts C(t, t−1) and D(t, t−1, t−2) obtained by collecting the feature amounts at a plurality of times, so that it is possible to substantially increase the hardware use efficiency by the processing corresponding to the dense matrix operation. As a result, the data transfer size and the transfer frequency of the main memory 103 and the DNN processor 101 can be reduced, and improvement in power efficiency can be expected.

Note that, in the third convolution processing example, the cases where the thinning rates are 1/2 and 1/3 have been exemplified, but the thinning rates other than 1/2 and 1/3 are also applicable. Note that the pattern of pixels to be thinned out may be any pattern as long as fluctuation in image deterioration can be tolerated. In particular, since the channel direction is convolved by the peripheral pixels of the target pixel, the channel direction is resistant to positional displacement, and it is easy to allow fluctuation of deterioration when thinning is performed in an arbitrary pattern.

The thinning processing can be executed not on the input image data I(t), I(t−1), and I(t−2) but on the feature amounts D(t), D(t−1), and D(t−2).

The input image data I(t), I(t−1), and I(t−2) and their feature amounts D(t), D(t−1), and D(t−2) also have dimensions in the channel direction. Therefore, also in the channel direction, pixel thinning can be applied similarly to the time direction.

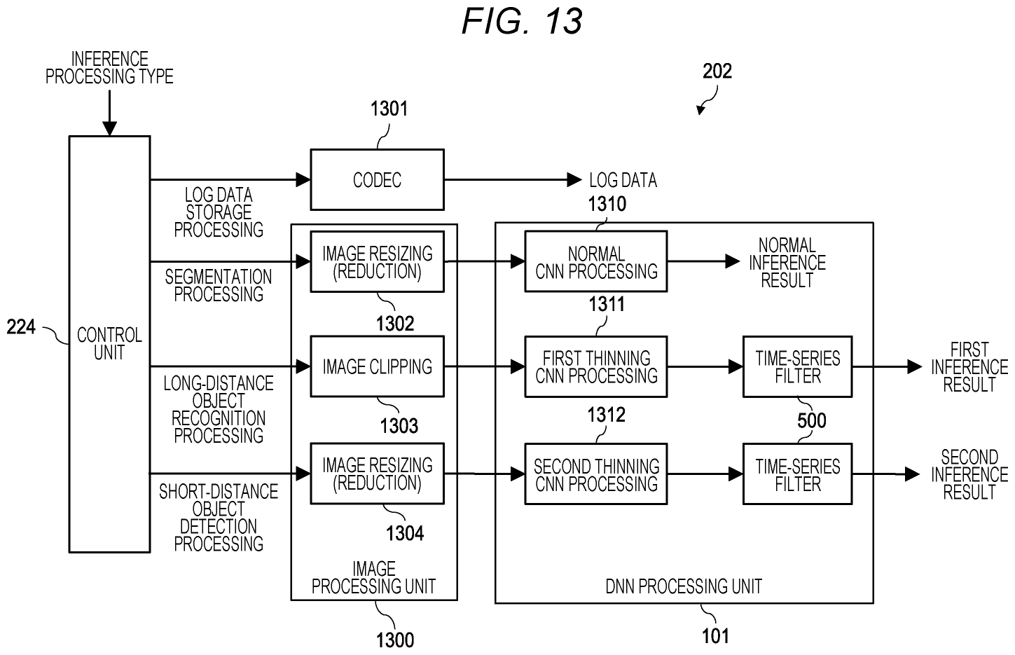

### <FIG. 13 Operation Switching Example of Signal Processing Unit 202>

FIG. 13 is an explanatory diagram illustrating an operation switching example of the signal processing unit 202. The control unit 224 switches between a codec 1301, a normal CNN processing 1310 in which the convolution arithmetic operation unit 222 performs a convolution arithmetic operation without thinning the input image data I, and a first thinning CNN processing 1311 and a second thinning CNN processing 1312 in which the convolution arithmetic operation unit 222 performs a convolution arithmetic operation after thinning the input image data I by the thinning processing unit 221 depending on the inference processing type. In the first thinning CNN processing 1311 and the second thinning CNN processing 1312, the thinning rate and the time constant to be applied are different.

Specifically, for example, the control unit 224 accepts the selection of any one of log data storage processing, segmentation processing, long-distance object recognition processing, and short-distance object detection processing as the inference processing type.

In a case where the control unit 224 accepts the selection of the log data storage processing as the inference processing type, the control unit 224 selects the codec 1301 and controls the signal processing unit 202 to output the log data to the codec 1301. Since the log data itself is required in the log data storage processing, the control unit 224 controls to send the log data to the codec 1301 instead of the thinning processing unit 221 of the input image data I. The codec 1301 may be implemented in the DNN processor 101, or may be implemented by causing the general-purpose processor 102 to execute a program stored in the main memory 103.

In a case where the control unit 224 accepts the selection of the segmentation processing as the inference processing type, the control unit 224 performs control to select an image processing unit 1300 and the DNN processor 101, cause the image processing unit 1300 to execute image resizing 1302 on the input image data I, and perform the normal CNN processing (convolution arithmetic operation by the product-sum operation unit 111 without thinning processing) 1302 on the input image data I after the resizing. The DNN processor 101 outputs a normal inference result. As a result, the operation amount is reduced as compared with a case where the image resizing 1302 is not executed.

In a case where the control unit 224 accepts the selection of the long-distance object recognition processing among the object recognition as the inference processing type, the control unit 224 performs control to select the image processing unit 1300 and the DNN processor 101, cause the image processing unit 1300 to execute image clipping 1303 of the long-distance object from the input image data I, and cause the DNN processor 101 to execute filtering of the clipped portion of the input image data I by the first thinning CNN processing 1311 and the time-series filter 500. As a result, a first inference result is output.

In a case where the control unit 224 accepts the selection of the short-distance object detection processing among the object recognition as the inference processing type, the control unit 224 performs control to select the image processing unit 1300 and the DNN processor 101, execute image resizing 1304 for detecting a short-distance object by the image processing unit 1300 from the input image data I, and cause the DNN processor 101 to execute filtering on the resized input image data I by the second thinning CNN processing 1312 and the time-series filter 500. As a result, a second inference result is output.

Note that although the control unit 224 has accepted the selection of any of the segmentation processing, the long-distance object recognition processing, and the short-distance object detection processing as the inference processing type, the control unit may further accept a resolution level as the inference processing type.

For example, in a case where the control unit 224 accepts the selection of a low resolution indicating that the resolution is less than a predetermined resolution and the segmentation processing, the control unit 224 selects and executes the image resizing 1302 and the normal CNN processing 1310.

When accepting the selection of a high resolution indicating the predetermined resolution or more and the object recognition, the control unit 224 selects the image clipping 1303 and causes the image processing unit 1300 to execute the image clipping 1303 of the target region in the input image data I.

In this case, the control unit 224 selects the long-distance object recognition processing when the subject distance of the target object is a predetermined distance or more. In this case, the moving speed of the object on the target region clipped out by the image clipping 1303 is equal to or relatively slower than the moving speed of the moving body on which the inference device 100 is mounted. Therefore, the control unit 224 performs control to increase the time constant of the time-series filter 500.

When the subject distance of the target object is not the predetermined distance or more, the control unit 224 selects the short-distance object detection processing. In this case, the moving speed of the object on the target region clipped out by the image clipping 1303 is equal to or relatively faster than the moving speed of the moving body on which the inference device 100 is mounted. Since the image of the object becomes larger as the speed becomes relatively faster, the control unit 224 selects the image resizing 1304 and executes the image resizing 1304 of the target region clipped out by the image clipping 1303. Then, the control unit 224 performs control to reduce the time constant of the time-series filter 500.

In this way, the operation of the signal processing unit 202 can be switched, and the operation amount can be reduced and the object recognition accuracy can be improved.

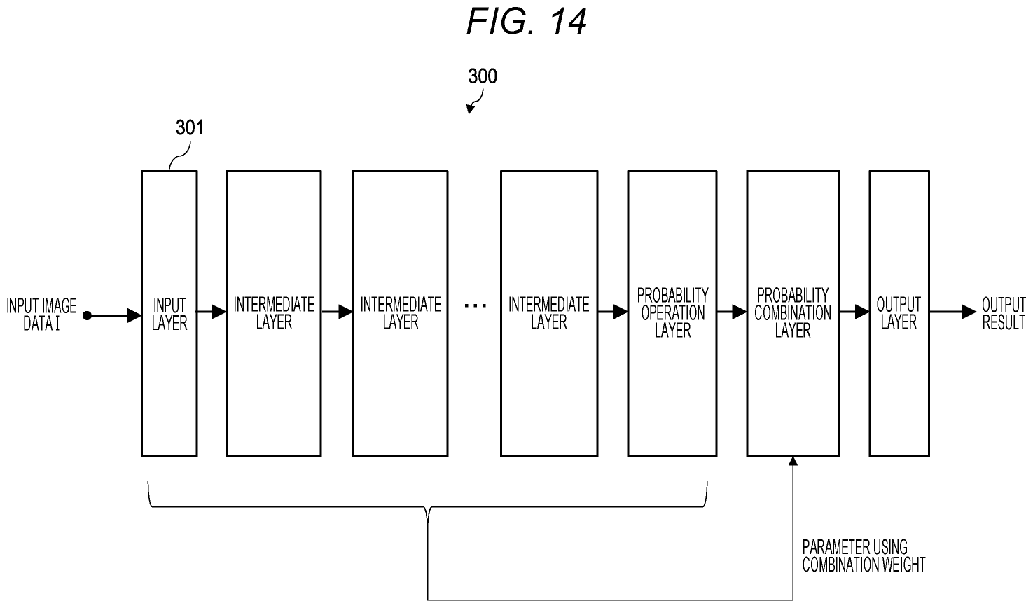

### <FIG. 14 Example of Combination Weight Control in Time Direction in Thinning CNN Processing>

FIG. 14 is an explanatory diagram illustrating an example of combination weight control in the time direction in the thinning CNN processing. The intermediate layer in FIG. 14 is an arbitrary neural network layer. The probability operation layer is a layer for obtaining a probability for each class, and is, for example, a softmax layer of a general DNN. The probability combination layer calculates a combination weight using a parameter from at least one of the results of the previous layer (see the above Expression (1) and the following Expressions (2) and (3)).

The thinning CNN processing is the first thinning CNN processing 1311 and the second thinning CNN processing 1312 illustrated in FIG. 13. The inference unit 223 reduces noise of an information source of the input image data I from the sensor or the camera and noise added by the thinning processing. Therefore, the inference unit 223 performs weighted addition on the input data used for combination by the time-series filters by using the estimation results of the respective noises, and improves the power ratio between the true value and the noise. Assuming that the inference results of the CNN used for the combination are X1 and X2, and the estimated noises are σ1 and σ2, a combination result Y is expressed by the following Expression (2).

$$Y = X 1 \times f ( σ1 ) + X 2 \times f ( σ2 ) \qquad ( 2 )$$

In the above Expression (2), the function f( ) is a function that determines a weight from estimated noise. Assuming that noise superimposed on X1 and X2 is uncorrelated, the function f( ) may be, for example, a reciprocal of noise power. In this case, the combination result Y is represented by the following Expression (3).

$$Y = X 1 \times ( 1 / σ 1 ) / ( 1 / σ1 + 1 / σ2 ) + X 2 \times ( 1 / σ2 ) / ( 1 / σ1 + 1 / σ2 ) \qquad ( 3 )$$

Although σ1 and σ2 in the above Expressions (2) and (3) are one-dimensional scalar quantities, a weight may be determined as a covariance matrix by substituting the function f( ) with a multi-dimensional Gaussian distribution and the function f( ) with σ1 and σ2. Assuming that the noise covariance matrix of X1 is S1 and the noise covariance matrix of X2 is S2, the combination result Y is expressed by the following Expression (4).

$$Y = X 1 \times S {1}^{- 1} / ( S {1}^{- 1} + S {2}^{- 1} ) + X 2 \times S {2}^{- 1} / ( S {1}^{- 1} + S {2}^{- 1} ) \qquad ( 4 )$$

The estimation values of the noise power and the noise covariance matrix in the above Expressions (2), (3), and (4) are obtained by calculating the variance and the covariance matrix using a part or a plurality of the feature amount matrices of the intermediate layer from the input layer of the convolutional neural network 300 with respect to X1 and X2 used for combination. The final combination result Y includes, in addition to the weight, reduction of the influence due to the lapse of time by a time constant.

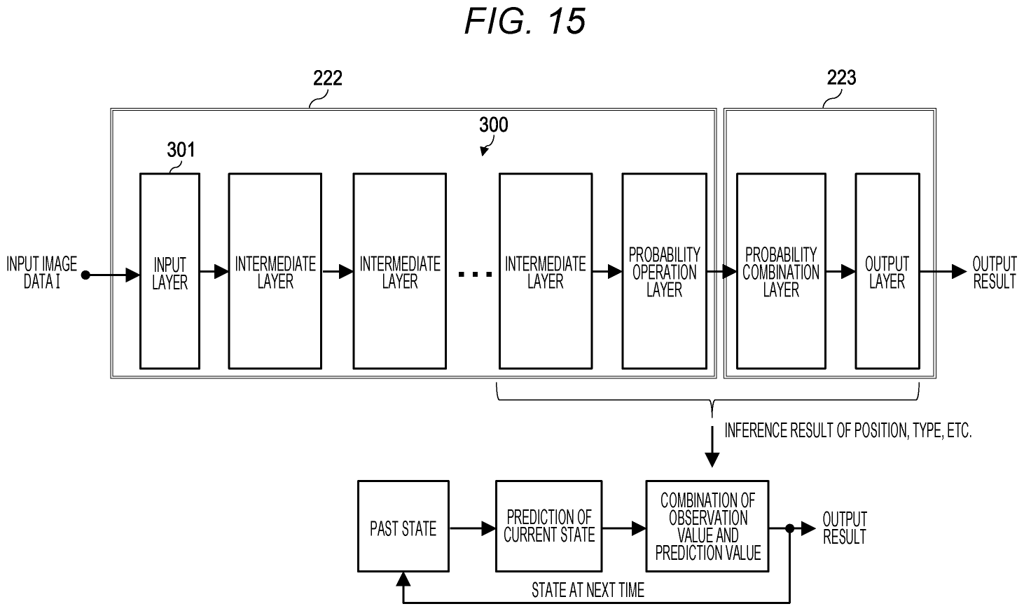

### <FIG. 15 Time-Series Filter Combination Example in Thinning CNN Processing>

FIG. 15 is an explanatory diagram illustrating an example of time-series filter combination in thinning CNN processing. The convolution arithmetic operation unit 222 may output temporally trackable information such as a position and a type on the image. In this case, the inference unit 223 combines a series of convolution arithmetic operation results output in time series from the convolution arithmetic operation unit 222 using a linear filter such as a Kalman filter in time series. In this case, the point used as the input of the combination is any layer after the final layer of the intermediate layer.

The inference unit 223 outputs the state at the current time, which is the combination result in the time-series filter, using the output result of one of the layers as an observation value. The state at the current time is generated by combining a prediction value obtained by predicting the state at the current time from the state before one hour and the observation value. The inference device 100 combines the prediction value and the observation value by, for example, a Kalman filter. In the Kalman filter, the uncertainty of the prediction value and the uncertainty of the observation value are expressed by covariance, and the prediction value and the observation value are combined by an inverse of these. The coefficient used for the combination is an optimum filter coefficient known as a Kalman gain. The updated current time is used as a prediction value of the next time. By sequentially and repeatedly combining the time-series signals, noise in the time direction is reduced.

As described above, according to the present embodiment, by performing the convolution arithmetic operation on the image data alternately thinned out in the continuous time direction, it is possible to achieve low power consumption by reducing the operation amount of the neural network, and it is possible to suppress accuracy deterioration by combining the subsequent inference results with the time-series filter. As described above, by reducing the heavy load convolution processing, highly efficient inference processing can be executed.

Further, the present invention is not limited to the above-described embodiments. Various modifications and equivalent configurations may be contained within the scope of claims. For example, the above-described embodiments are given in detail in order to help easy understating of the present invention. The present invention is not limited to be provided all the configurations described above. In addition, some of the configurations of a certain embodiment may be replaced with the configuration of the other embodiment. In addition, the configurations of the other embodiment may be added to the configurations of a certain embodiment. In addition, some of the configurations of each embodiment may be added, omitted, or replaced with respect to the configuration of the other embodiment.

In addition, the above-described configurations, functions, processing units, and processing means may be realized by a hardware configuration by setting some or all of the configurations using an integrated circuit, or may be realized by a software configuration by analyzing and performing a program to realize the functions by the processor.

The information of the program realizing functions, tables, and files may be stored in a memory device such as a memory, a hard disk, a Solid State Drive (SSD) or a recording medium such as an Integrated Circuit (IC) card, an SD card, and a Digital Versatile Disc (DVD).

In addition, only control lines and information lines considered to be necessary for explanation are illustrated, but not all the control lines and the information lines necessary for mounting are illustrated. In practice, almost all the configurations may be considered to be connected to each other.

What is claimed is:

1. An inference device comprising:
an input unit that inputs a plurality of pieces of image data continuous in a predetermined direction;
a thinning processing unit that executes thinning processing of thinning each of a plurality of pieces of image data input by the input unit in such a way that a pixel array indicating a plurality of patterns is repeated and pixels in a spatial direction do not overlap, and outputs a plurality of pieces of thinned image data;
a convolution arithmetic operation unit that performs a convolution arithmetic operation by applying a plurality of thinning filters configuring the plurality of patterns divided from a filter having a weighting factor to each of the plurality of pieces of thinned image data;
an inference unit that executes inference regarding the plurality of pieces of image data using a time-series filter on a basis of a plurality of convolution arithmetic operation results by the convolution arithmetic operation unit; and
an output unit that outputs an inference result by the inference unit.

2. An inference device comprising:
an input unit that inputs a plurality of pieces of image data continuous in a predetermined direction;
a thinning processing unit that executes thinning processing of thinning each of a plurality of pieces of image data input by the input unit in such a way that a pixel array indicating a plurality of patterns is repeated and pixels in a spatial direction do not overlap, and outputs a plurality of pieces of thinned image data;
a convolution arithmetic operation unit that combines a plurality of pieces of thinned image data thinned by the thinning processing unit to generate combined thinned image data, and applies a filter having a weighting factor to the combined thinned image data to perform a convolution arithmetic operation;
an inference unit that executes inference regarding the plurality of image data using a time-series filter on a basis of a convolution arithmetic operation result by the convolution arithmetic operation unit; and
an output unit that outputs an inference result by the inference unit.

3. The inference device according to claim 1, wherein the predetermined direction is a time direction.

4. The inference device according to claim 1, wherein the predetermined direction is a channel direction.

5. The inference device according to claim 1, comprising a control unit that controls the plurality of patterns.

6. The inference device according to claim 5, wherein the control unit controls a number of the plurality of patterns.

7. The inference device according to claim 5, wherein the control unit controls the plurality of patterns on a basis of a distance to a subject in the image data.

8. The inference device according to claim 5, wherein the control unit controls the plurality of patterns in a case where object recognition is selected, and controls not to execute the thinning processing in a case where processing other than the object recognition is selected.

9. The inference device according to claim 8, comprising an image processing unit that performs image processing on the image data,
wherein the control unit controls the image processing unit to clip out an image region of a subject from the image data when a distance to the subject in the image data is a predetermined distance or more, and
the thinning processing unit executes the thinning processing on a plurality of image regions of the subject clipped out from each of the plurality of pieces of image data by the image processing unit.

10. The inference device according to claim 8, comprising an image processing unit that performs image processing on the image data,
wherein the control unit controls the image processing unit to reduce the image data when a distance to a subject in the image data is less than a predetermined distance, and
the thinning processing unit executes the thinning processing on the plurality of pieces of image data after reduction obtained by reducing each of the plurality of pieces of image data by the image processing unit.

11. An inference method comprising:
inputting a plurality of pieces of image data continuous in a predetermined direction;
thinning each of a plurality of pieces of image data input by the inputting in such a way that a pixel array indicating a plurality of patterns is repeated and pixels in a spatial direction do not overlap, and outputting a plurality of pieces of thinned image data;
performing a convolution arithmetic operation by applying a plurality of thinning filters configuring the plurality of patterns divided from a filter having a weighting factor to each of the plurality of pieces of thinned image data;
executing inference regarding the plurality of pieces of image data using a time-series filter on a basis of a plurality of convolution arithmetic operation results by the convolution arithmetic operation; and
outputting an inference result by the inference.
